(19) United States
(12) Patent Application Publication
(10) Pub. No.: US 2026/0058284 A1
(43) Pub. Date: Feb. 26, 2026

(54) POWER STORAGE APPARATUS

(71) Applicant: TOYOTA JIDOSHA KABUSHIKI KAISHA, Toyota-shi (JP)

(72) Inventors: Taro MATSUSHITA, Toyokawa-shi (JP); Hiroaki ISHIKAWA, Toyota-shi (JP)

(73) Assignee: TOYOTA JIDOSHA KABUSHIKI KAISHA, Toyota-shi (JP)

(21) Appl. No.: 19/255,023

(22) Filed: Jun. 30, 2025

(30) Foreign Application Priority Data
Aug. 22, 2024 (JP) 2024-140711

(51) Int. Cl. H01M 50/262; H01G 9/08; H01M 10/613; H01M 10/6556; H01M 10/6561; H01M 10/6567; H01M 50/209; H01M 50/358; H01M 50/367

(52) U.S. Cl. CPC H01M 50/262; H01G 9/08; H01M 10/613; H01M 10/6556; H01M 10/6561; H01M 10/6567; H01M 50/209; H01M 50/358; H01M 50/367

(57) ABSTRACT

A power storage apparatus includes: a power storage module including a plurality of power storage cells and a module case; and a power storage case. A first guide groove that extends along a first direction is formed on one of a first inner surface of the power storage case and a first outer surface of the module case. A first protruding portion that engages with the first guide groove is formed on another of the first inner surface and the first outer surface. A second guide groove that extends along the first direction is formed on one of a second inner surface of the power storage case facing the first inner surface and a second outer surface of the module case. A second protruding portion that engages with the second guide groove is formed on another of the second inner surface and the second outer surface.

### CROSS-REFERENCES TO RELATED APPLICATION

The present disclosure claims priority under 35 U.S.C. § 119 to Japanese Patent Application No. 2024-140711, filed on Aug. 22, 2024, which is incorporated herein by reference in its entirety.

### BACKGROUND

### Technical Field

The present disclosure relates to a power storage apparatus, and more particularly to a power storage apparatus included in a moving body.

### Background Art

JP 2020-155367 A discloses a power storage apparatus mounted on a vehicle. The power storage apparatus includes a plurality of power storage modules and a housing case that houses the plurality of power storage modules. The housing case includes an upper case and a lower case.

### SUMMARY

A power storage apparatus is desirable to have a structure that allows a power storage module to be easily assembled into a power storage case that houses the power storage module. The power storage apparatus is also desirable to have a structure that makes it difficult for the power storage module to come off from the power storage case when an external force acts on the power storage case.

A power storage apparatus according to the present disclosure includes a power storage module and a power storage case. The power storage module includes a plurality of power storage cells and a module case that houses the plurality of power storage cells. The power storage case houses the power storage module. A first guide groove that extends along a first direction is formed on one of a first inner surface of the power storage case and a first outer surface of the module case facing the first inner surface. A first protruding portion that engages with the first guide groove is formed on another of the first inner surface and the first outer surface. A second guide groove that extends along the first direction is formed on one of a second inner surface of the power storage case facing the first inner surface and a second outer surface of the module case facing the second inner surface. A second protruding portion that engages with the second guide groove is formed on another of the second inner surface and the second outer surface.

According to the power storage apparatus of the present disclosure, when the power storage module is inserted into the power storage case while the positions of the first and second protruding portions are respectively aligned with the positions of the first and second guide grooves, the power storage module slides along the first direction while the first and second protruding portions are respectively guided by the first and second guide grooves and moves to a predetermined assembly position. In this manner, a structure that facilitates assembly of the power storage module into the power storage case is obtained. Inside the power storage case, the first guide groove and the first protruding portion are engaged with each other on the side of the first inner surface, and the second guide groove and the second protruding portion are engaged with each other on the side of the second inner surface facing the first inner surface. Therefore, a structure in which the power storage module is less likely to come off from the power storage case when an external force acts on the power storage case is obtained.

### BRIEF DESCRIPTION OF THE DRAWINGS

FIG. 1 is an exploded perspective view of a power storage apparatus according to an embodiment;

FIG. 2A is a cross-sectional view illustrating a first shape example of first and second guide grooves and first and second protruding portions;

FIG. 2B is a cross-sectional view illustrating a second shape example of first and second guide grooves and first and second protruding portions;

FIG. 3 is a cross-sectional view illustrating a configuration of the power storage apparatus before and after a power storage module is assembled;

FIG. 4 is an exploded perspective view of the power storage module;

FIG. 5 is a view of two power storage modules viewed from above;

FIG. 6 is a perspective view of a power storage case in which components, such as the power storage module, are assembled;

FIG. 7 is a cross-sectional view showing another structural example of a case body in which a guide groove that engages with a protruding portion having a cooling passage is formed; and

FIG. 8 is a schematic view showing a cross section of a power storage case according to a comparative example.

### DETAILED DESCRIPTION

Embodiments of the present disclosure will be described with reference to the accompanying drawings. In the drawings, the same reference numerals are given to the same elements, and redundant description will be omitted or simplified.

### 1. Configuration of Power Storage Apparatus

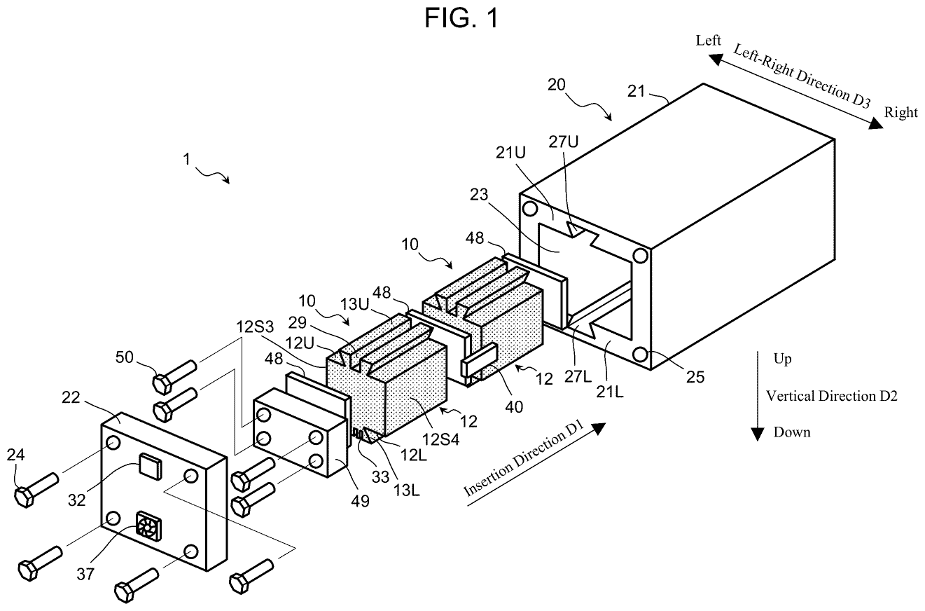

FIG. 1 is an exploded perspective view of a power storage apparatus 1 according to the present embodiment. The power storage apparatus 1 is included in, for example, a moving body, and supplies electric power for moving the moving body to the moving body. The moving body referred to here is, for example, a vehicle (e.g., an electric vehicle such as a battery electric vehicle (BEV)) or a robot.

### 1-1. Power Storage Module and Power Storage Case

The power storage apparatus 1 includes a power storage module 10 and a power storage case 20. The power storage case 20 is formed to house the power storage module 10. The power storage apparatus 1 is included in (in other words, mounted on) a moving body as a power storage pack, for example. In this example, the power storage case 20 corresponds to a case (pack case) of the power storage pack.

Alternatively, in another example of the power storage apparatus 1 included in a moving body, the power storage case 20 may be a component of the moving body (e.g., a body component of a vehicle).

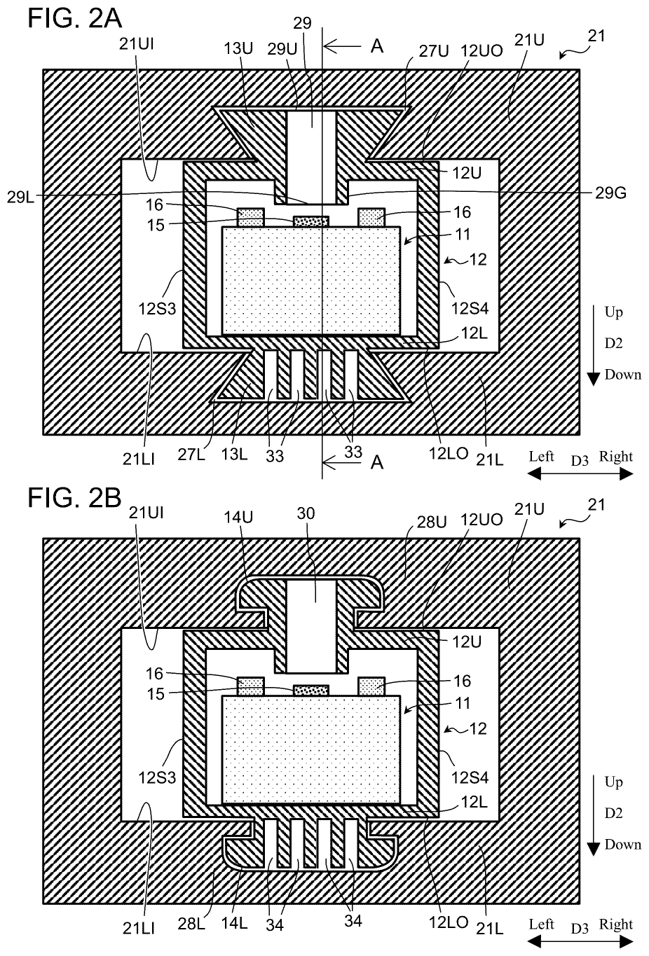

In the example shown in FIG. 1, the power storage apparatus 1 includes two power storage modules 10. However, the number of power storage modules included in the “power storage apparatus” according to the present disclosure may be one or three or more. The power storage module 10 includes a plurality of power storage cells 11 (see FIG. 2A) and a module case 12. The module case 12 houses the plurality of power storage cells 11. The power storage cell 11 is, for example, a battery cell, but may be a capacitor cell.

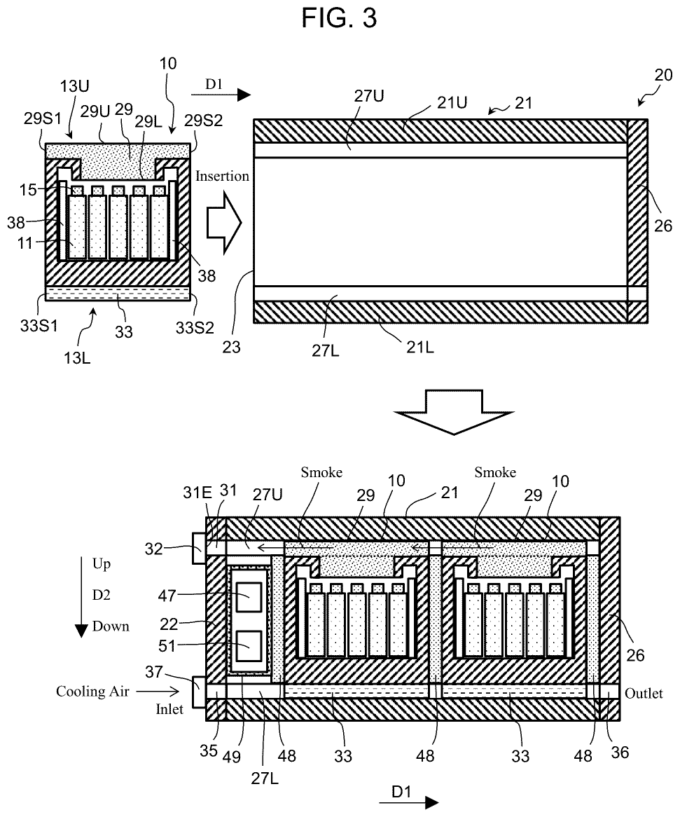

The power storage case 20 includes a case body 21 and a case lid 22. The case body 21 has, for example, a rectangular parallelepiped shape, but may have a cubic shape. One end of the case body 21 in the longitudinal direction is open as an opening 23. The components of the power storage apparatus 1, such as the power storage module 10, are inserted (i.e., assembled) into the case body 21 along an insertion direction D1 (first direction) parallel to the longitudinal direction. The case lid 22 is used to close the opening 23 after the components are housed in the case body 21. The case lid 22 is attached to the case body 21 by, for example, bolts 24. The case body 21 is formed with fastening holes 25 for the bolts 24. The other end of the case body 21 in the longitudinal direction is closed by a cover 26 (see FIG. 3) fixed to the case body 21 by fastening or welding, for example. Alternatively, the case body 21 and the cover 26 may be integrally formed.

### 1-2. Guide Grooves and Protruding Portions

Reference is made to FIGS. 2A, 2B, and 3 in addition to FIG. 1. Each of FIGS. 2A and 2B is a cross-sectional view of the power storage module 10 inserted into the power storage case 20 as viewed from the insertion direction D1. FIG. 3 is a cross-sectional view illustrating a configuration of the power storage apparatus 1 before and after the power storage module 10 is assembled. The position of the cross section shown in FIG. 3 is represented by a line A-A in FIG. 2A. In addition, FIG. 2B shows the second shape example of “first and second guide grooves” and “first and second protruding portions” as described below.

The module case 12 has, for example, a substantially or roughly rectangular parallelepiped shape, or a substantially or roughly cubic shape. For example, the module case 12 is formed using a metal material such as iron or aluminum. As shown in FIG. 2A, the module case 12 includes an upper wall 12U located above the power storage cell 11 in a vertical direction D2, and a lower wall 12L located below the power storage cell 11 in the vertical direction D2. Similarly, the case body 21 includes an upper wall 21U and a lower wall 21L. For example, the case body 21 is formed using a metal material such as iron or aluminum. The case body 21 may be manufactured, for example, using an extruded material, or may be manufactured by welding a plurality of sheet metal members together. In addition, the thickness of the case body 21 is, for example, 10 to 30 mm, and is larger than the thickness of a general power storage case (for example, JP 2020-155367 A) having a lower case and an upper case for housing a power storage module.

An inner surface 21UI (first inner surface) of the upper wall 21U of the case body 21 is provided with a guide groove 27U (first guide groove). As shown in FIGS. 1 and 3, the guide groove 27U is formed to extend along the insertion direction D1. An inner surface 21LI (second inner surface) of the lower wall 21L facing the inner surface 21UI is provided with a guide groove 27L (second guide groove). Similarly to the guide groove 27U, the guide groove 27L is formed to extend along the insertion direction D1. In one example, the formation range of each of the guide grooves 27U and 27L covers the entire case body 21 in the insertion direction D1 (i.e., from the opening 23 (one end) of the case body 21 to the other end) (see FIG. 3).

On the other hand, an outer surface 12UO (first outer surface) of the upper wall 12U of the module case 12 is provided with a protruding portion 13U (first protruding portion). The outer surface 12UO faces the inner surface 21UI. The protruding portion 13U is formed so as to protrude vertically upward from the outer surface 12UO and engage with the guide groove 27U inside the guide groove 27U. An outer surface 12LO (second outer surface) of the lower wall 12L is provided with a protruding portion 13L (second protruding portion). The outer surface 12LO faces the inner surface 21LI.

Similarly to the protruding portion 13U, the protruding portion 13L is formed so as to protrude vertically downward from the outer surface 12LO and engage with the guide groove 27L inside the guide groove 27L. Each of the protruding portions 13U and 13L is formed to extend along the insertion direction D1. In one example, the formation range of each of the protruding portions 13U and 13L covers over the entire module case 12 in the insertion direction D1 (see FIG. 1).

### First Shape Example

In the first shape example shown in FIG. 2A, the guide groove 27U has a tapered cross-sectional shape that becomes thicker vertically upward when viewed from the insertion direction D1 (in other words, a cross-sectional shape of an inverted triangle whose base is located vertically upward). The protruding portion 13U has a tapered cross-sectional shape similar to that of the guide groove 27U and is engaged with the guide groove 27U. More specifically, the protruding portion 13U has a tapered cross-sectional shape that is slightly smaller than the tapered cross-sectional shape of the guide groove 27U.

Similarly, the guide groove 27L has a tapered cross-sectional shape that becomes thicker vertically downward when viewed from the insertion direction D1 (in other words, a cross-sectional shape of a triangle whose base is located vertically downward). The protruding portion 13L has a tapered cross-sectional shape similar to that of the guide groove 27L and is engaged with the guide groove 27L. More specifically, the protruding portion 13L has a tapered cross-sectional shape slightly smaller than the tapered cross-sectional shape of the guide groove 27L. In addition, the guide grooves 27U and 27L having the cross-sectional shape according to the first shape example can be said to be an example of a dovetail-shaped guide groove.

A direction perpendicular to each of the vertical direction D2 and the insertion direction D1 is referred to as a “left-right direction D3”. Due to having the tapered cross-sectional shape described above, the protruding portion 13U is engaged with the guide groove 27U such that the movement of the module case 12 with respect to the power storage case 20 is restricted in each of the vertical direction D2 and the left-right direction D3. Similarly, the protruding portion 13L is engaged with the guide groove 27L such that the movement of the module case 12 with respect to the power storage case 20 is restricted in each of the vertical direction D2 and the left-right direction D3.

### Second Shape Example

In the second shape example shown in FIG. 2B, the case body 21 includes guide grooves 28U and 28L instead of the guide grooves 27U and 27L, and the module case 12 includes protruding portions 14U and 14L instead of the protruding portions 13U and 13L. The guide groove 28U has a cross-sectional shape (in other words, a T-shaped cross-sectional shape) in which the width in the left-right direction D3 is narrower on the lower side in the vertical direction D2 and the width in the left-right direction D3 is wider on the upper side in the vertical direction D2 when viewed from the insertion direction D1. The protruding portion 14U has a cross-sectional shape similar to that of the guide groove 28U and is engaged with the guide groove 28U. More specifically, the protruding portion 14U has a cross-sectional shape that is slightly smaller than the cross-sectional shape of the guide groove 28U.

Similarly to the guide groove 28U, the guide groove 28L has a cross-sectional shape (in other words, an inverted T-shaped cross-sectional shape) in which the width in the left-right direction D3 is narrower on the upper side in the vertical direction D2 and the width in the left-right direction D3 is wider on the lower side in the vertical direction D2 when viewed from the insertion direction D1. The protruding portion 14L has a cross-sectional shape similar to that of the guide groove 28L and is engaged with the guide groove 28L. More specifically, the protruding portion 14L has a cross-sectional shape that is slightly smaller than the cross-sectional shape of the guide groove 28L. In addition, the guide grooves 28U and 28L having the cross-sectional shape according to the second shape example can be said to be another example of a dovetail-shaped guide groove.

Due to having the cross-sectional shape described above, the protruding portion 14U is engaged with the guide groove 28U such that the movement of the module case 12 with respect to the power storage case 20 is restricted in each of the vertical direction D2 and the left-right direction D3. Similarly, the protruding portion 14L is engaged with the guide groove 28L such that the movement of the module case 12 with respect to the power storage case 20 is restricted in each of the vertical direction D2 and the left-right direction D3.

### Smoke Exhaust Passage

As shown in FIG. 2A, a smoke exhaust passage 29 may be formed inside the protruding portion 13U of the module case 12. In the example described here, each of the power storage cells 11 is a battery cell having a smoke exhaust valve (i.e., safety valve) 15. The smoke exhaust valve 15 is configured to open in accordance with an increase in the internal pressure of the power storage cell 11. Each of the power storage cells 11 is arranged in the module case 12 such that the smoke exhaust valve 15 faces upward in the vertical direction D2, for example. In addition, in one example, the smoke exhaust valve 15 is disposed between a pair of electrode terminals 16 on the upper surface of the power storage cell 11.

A “smoke exhaust route” for guiding gas (i.e., smoke) emitted from the smoke exhaust valve 15 of each power storage cell 11 to the outside of the power storage case 20 may be provided inside the power storage case 20. The smoke exhaust passage 29 functions as the smoke exhaust route together with the guide groove 27U and a passage 31 (see FIG. 3). The passage 31 is formed so as to penetrate the case lid 22 along the insertion direction D1 at a position corresponding to the guide groove 27U.

The smoke exhaust passage 29 communicates with the inside of the module case 12. More specifically, in one example, the smoke exhaust passage 29 is formed to have a guide portion 29G that protrudes downward from the module case 12 in the vertical direction D2. Further, as shown in FIG. 2A, the smoke exhaust valve 15 of each power storage cell 11 is disposed directly below a lower end 29L of the smoke exhaust passage 29 in the vertical direction D2.

Moreover, as shown in FIGS. 1 and 3, the smoke exhaust passage 29 is formed to extend along the insertion direction D1. Each of side ends 29S1 and 29S2 of the smoke exhaust passage 29 in the insertion direction D1 is open and communicates with the guide groove 27U. An upper end 29U of the smoke exhaust passage 29 may be open to communicate with the guide groove 27U as shown in FIG. 2A or may be closed.

According to the smoke exhaust passage 29 formed as described above, the smoke exhausted from a power storage cell 11 can be made to flow out of the module case 12 by using the protruding portion 13U. More specifically, the end of the guide groove 27U on the cover 26 side is closed by the cover 26. Therefore, as shown in FIG. 3, the smoke exhausted from any of the power storage cells 11 in the power storage module 10 can be guided to the outlet (i.e., an outer end 31E of the passage 31) of the smoke exhaust route via the smoke exhaust passage 29, the guide groove 27U, and the passage 31. In addition, in the example in which the smoke exhaust passage 29 has the guide portion 29G described above, the smoke can be guided into the smoke exhaust passage 29 more effectively by using the guide portion 29G. Further, a relief valve 32 is provided at the outlet. The relief valve 32 is configured to open when subjected to a high pressure of the exhausted smoke.

In the second shape example as well, as shown in FIG. 2B, a smoke exhaust passage 30 similar to the smoke exhaust passage 29 may be formed inside the protruding portion 14U.

### Cooling Passage

As shown in FIG. 2A, a cooling passage 33 may be formed inside the protruding portion 13L of the module case 12. A “cooling route” for flowing a refrigerant for cooling the plurality of power storage cells 11 of each power storage module 10 may be provided inside the power storage case 20. The cooling passage 33 located in the guide groove 27L functions as the coolant route together with passages 35 and 36. The passage 35 is formed so as to penetrate the case lid 22 along the insertion direction D1 at a position corresponding to the guide groove 27L. Similarly, the passage 36 is formed so as to penetrate the cover 26 along the insertion direction D1 at a position corresponding to the guide groove 27L.

The cooling passage 33 is closed at the upper side of the protruding portion 13L in the vertical direction D2. That is, the cooling passage 33 is formed so as not to communicate with the inside of the module case 12. Further, as shown in FIG. 3, the cooling passage 33 is formed to extend along the insertion direction D1. Each of side ends 33S1 and 33S2 of the cooling passage 33 in the insertion direction D1 is open and communicates with the guide groove 27L.

The refrigerant flowing through the cooling passage 33 is, for example, air (outside air). In the example of the protruding portion 13L shown in FIG. 2A, the cooling passage 33 is formed by using a fin shape that protrudes downward from the protruding portion 13L in the vertical direction D2. In addition, the cooling passage 33 is open at the lower end of the protruding portion 13L but may be a closed passage inside the protruding portion 13L.

The passage 35 formed in the case lid 22 is provided with a fan 37. The fan 37 operates in accordance with an instruction from an ECU 51 described below when, for example, cooling of the power storage module 10 is needed, and causes cooling air (i.e., the refrigerant) to circulate through a cooling route including the cooling passage 33.

This makes it possible to cool the plurality of power storage cells 11 via the module case 12. More specifically, in the example of the power storage cells 11 arranged as shown in FIG. 2A, each power storage cell 11 can be effectively cooled by directly cooling, with the cooling air, the lower wall 12L of the module case 12 that is in contact with each power storage cell 11.

Additionally, the electric power for operating the fan 37 may be supplied from the power storage module 10. The fan 37 may be configured to push air into the cooling route or may be configured to suck air out of the cooling route. The fan 37 may be provided in the passage 36 instead of the passage 35. Further, the refrigerant flowing through the cooling route including the cooling passage 33 may be a liquid refrigerant, such as cooling water.

In the second shape example as well, as shown in FIG. 2B, a cooling passage 34 similar to the cooling passage 33 may be formed inside the protruding portion 14L.

### 1-3. Further Description of Structure of Components

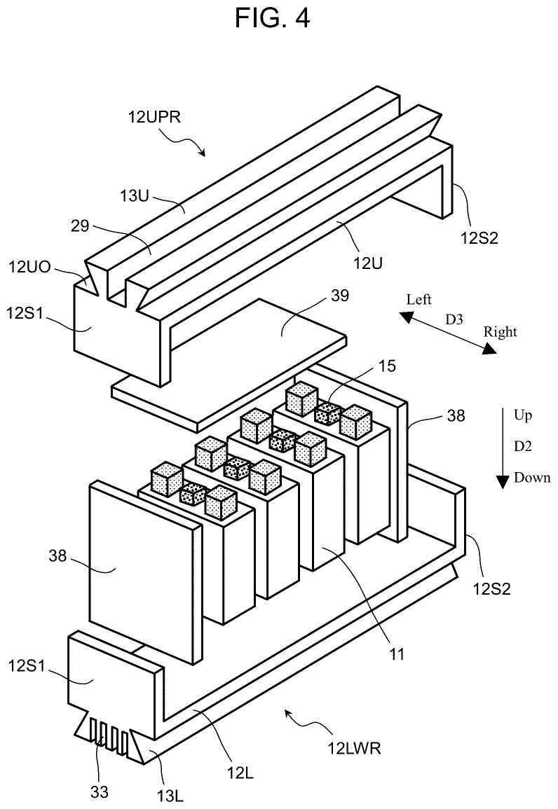

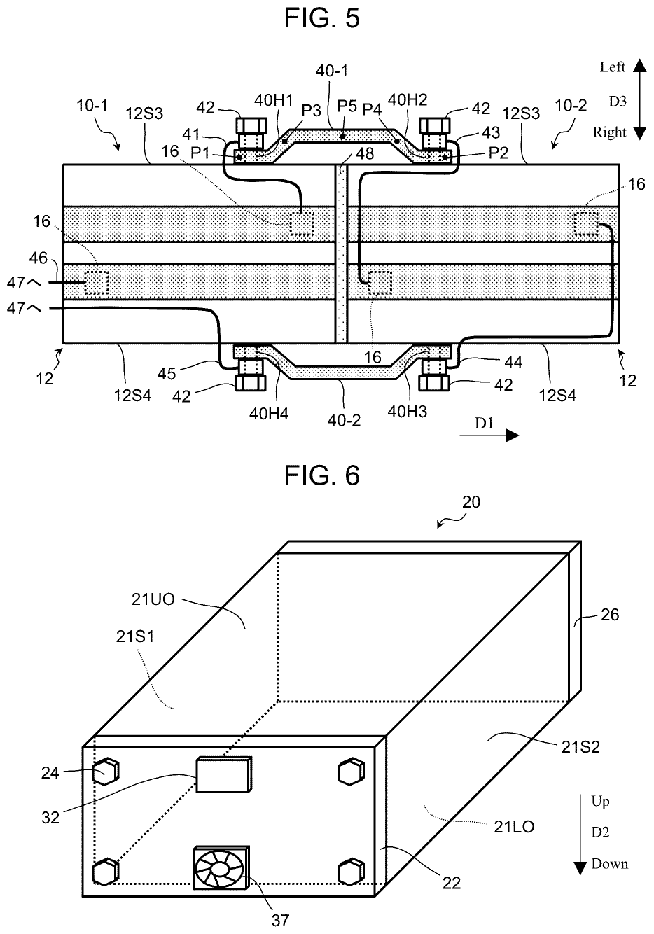

Reference is made to FIGS. 4 and 5 in addition to FIGS. 1, 2A, 2B, and 3. FIG. 4 is an exploded perspective view of the power storage module 10. FIG. 5 is a view of two power storage modules 10 viewed from above.

As shown in FIG. 4, the module case 12 may be a combination of an upper case 12UPR and a lower case 12LWR that are divided into two parts, for example, above and below in the vertical direction D2. The upper case 12UPR integrally includes an upper wall 12U including the protruding portion 13U (or 14U) and the upper halves of two side walls 12S1 and 12S2. The lower case 12LWR integrally includes a lower wall 12L including the protruding portion 13L (or 14L) and the lower halves of the two side walls 12S1 and 12S2. In FIG. 4, in order to show the internal structure of the power storage module 10, the two side walls 12S3 and 12S4 (see FIG. 2A) of the module case 12 in the left-right direction D3 are not illustrated. For example, the upper half of each of the side walls 12S3 and 12S4 may be formed integrally with the upper case 12UPR, and similarly, the lower half of each of the side walls 12S3 and 12S4 may be formed integrally with the lower case 12LWR. The module case 12 may be formed by being divided in any form different from those described above.

In the example shown in FIG. 4, the plurality of power storage cells 11 are a plurality of battery cells stacked in the same direction as the insertion direction D1. The restraint of the plurality of power storage cells 11 in one power storage module 10 is performed as follows, for example. That is, the plurality of power storage cells 11 are housed in the lower case 12LWR together with a pair of end plates 38 in a state in which a compressive load is applied to the plurality of power storage cells 11 from both sides in the direction described above by the pair of end plates 38. The upper case 12UPR and the lower case 12LWR (more specifically, two side walls, i.e., the 12S1 and the 12S2) are then fixed to the end plates 38 by a technique such as welding.

Moreover, as shown in FIG. 4, a bus bar module 39 is disposed above each power storage cell 11 in the module case 12. The bus bar module 39 includes a plurality of inter-cell bus bars for electrically connecting the electrode terminals 16 of the respective power storage cells 11 in series or in parallel. Since one of the purposes of FIG. 4 is to show the arrangement of the bus bar module 39 with respect to each of the power storage cells 11 inside the module case 12, the bus bar module 39 is simply represented by a single plate. In addition, the bus bar module 39 is formed so as to secure a space between the smoke exhaust valve 15 of each power storage cell 11 and the protruding portion 13U.

Furthermore, as shown in FIGS. 1 and 5, the power storage apparatus 1 includes an inter-module bus bar 40 disposed outside each module case 12. For example, two inter-module bus bars 40 are provided as inter-module bus bars 40-1 and 40-2. For ease of description, the power storage module 10 located on the rear side in the insertion direction D1 will be referred to as a power storage module 10-1, and the power storage module 10 located on the front side in the insertion direction D1 will be referred to as a power storage module 10-2. Each of the bus bars 40-1 and 40-2 is attached to the respective module case 12 via an insulating material (not shown) so as to connect the two adjacent power storage modules 10-1 and 10-2. In addition, the inter-module bus bar 40 is provided, for example, at the center of each module case 12 in the vertical direction D2.

To be more specific, the bus bar 40-1 has two fastening holes 40H1 and 40H2. As shown in FIG. 5, a conductive member 41 is led out from the inside of the module case 12 to the outside through a hole (not shown) formed in the module case 12 of the power storage module 10-1. Each of the conductive member 41 and conductive members 43-46 described below is, for example, a bus bar or a cable. In an example of a series connection in which the power storage cells 11 included in the two power storage modules 10-1 and 10-2 are connected in series, one end of the conductive member 41 is connected to the negative electrode terminal 16 that is located at the lowest potential among the power storage cells 11 included in the power storage module 10-1. The bus bar 40-1 is fastened to the side wall 12S3 of the power storage module 10-1 by a bolt 42 together with the other end of the conductive member 41 via the fastening hole 40H1. The bus bar 40-1 is also fastened to the side wall 12S3 of the power storage module 10-2 by a bolt 42 together with one end of the conductive member 43 via the fastening hole 40H2. In the example of the series connection, the other end of the conductive member 43 is connected to the positive electrode terminal 16 that is located at the highest potential among the power storage cells 11 included in the power storage module 10-2. According to this configuration, the adjacent power storage modules 10-1 and 10-2 are mechanically coupled with each other by using the bus bar 40-1 for electrically connecting the conductive member 41 of one power storage module 10-1 to the conductive member 43 of the other power storage module 10-2.

Similarly, the bus bar 40-2 has two fastening holes 40H3 and 40H4. The bus bar 40-2 is fastened to the side wall 12S4 of the power storage module 10-2 by a bolt 42 together with one end of the conductive member 44 via the fastening hole 40H3. In the example of the series connection, the other end of the conductive member 44 is connected to the negative electrode terminal 16 that is located at the lowest potential among the power storage cells 11 included in the power storage module 10-2. The bus bar 40-2 is also fastened to the side wall 12S4 of the power storage module 10-1 by a bolt 42 together with one end of the conductive member 45 via the fastening hole. 40H4. In the example of the series connection, the other end of the conductive member 45 is connected to a junction box (J/B) 47 together with one end of the conductive member 46. The other end of the conductive member 46 is connected to the positive electrode terminal 16 that is located at the highest potential among the power storage cells 11 included in the power storage module 10-1. According to this configuration, the adjacent power storage modules 10-1 and 10-2 are mechanically coupled with each other by using the bus bar 40-2 interposed in a conductive path for leading the conductive member 44 from the power storage module 10-2 to the J/B 47.

In the example illustrated in FIG. 5, the inter-module bus bar 40-1 has a hat structure. That is, the bus bar 40-1 is formed to have a pair of fastening portions P1 and P2 in which the fastening hole 40H1 and 40H2 are respectively formed, a pair of standing portions P3 and P4 that respectively stand up in a direction away from the module case 12 with respect to the pair of fastening portions P1 and P2, and an intermediate portion P5 that connects between the pair of standing portions P3 and. P4. This makes it possible to effectively absorb vibrations acting on the two power storage modules 10 in the insertion direction D1, compared to an example in which the inter-module bus bar is formed of a simple flat plate. The same applies to the bus bar 40-2. In addition, by providing both the bus bars 40-1 and 40-2, the plurality of power storage modules 10 can be connected while reducing the force acting on one bus bar 40 when the plurality of power storage modules 10 are assembled to or removed from the power storage case 20. However, the connection of the plurality of power storage modules 10 may be performed using only one of the bus bars 40-1 and 40-2.

Moreover, as shown in FIGS. 1 and 3, in order to fill the gap between two adjacent power storage modules 10, an elastic member 48 may be arranged so as to be interposed between the two power storage modules 10. The elastic member 48 is, for example, a rubber member, and more specifically, is desirably soft rubber from the viewpoint of improving adhesion. In addition, from the viewpoint of improving ease of assembly, the elastic member 48 may be attached to, for example, the module case 12 of one of the two adjacent power storage modules 10 using, for example, a double-sided tape. Further, in order to fill a gap as well, an elastic member 48 may be arranged so as to be interposed between the cover 26 (see FIG. 3) and the power storage module 10 facing the cover 26, or an elastic member 48 may be arranged so as to be interposed between a restraint plate 49 and the power storage module 10 facing the restraint plate 49.

Furthermore, as shown in FIGS. 1 and 3, the restraint plate 49 is provided in order to press and fix the power storage modules 10 inserted into the power storage case 20 against the power storage case 20. That is, the insertion direction D1 of the power storage module 10 corresponds to a direction in which the power storage module 10 is pressed against the power storage case 20. The restraint plate 49 is attached to the power storage case 20 by, for example, bolts 50. Fastening holes (not shown) for the bolts 50 are formed in the inner wall of the power storage case 20 (e.g., the cover 26).

By using the restraint plate 49, the module case 12 of each power storage module 10 is fixed to the power storage case 20 such that the movement of the module case 12 in the insertion direction D1 with respect to the power storage case 20 is restrained.

The restraint plate 49 is formed using, for example, a metal material such as iron. The restraint plate 49 may have, for example, a hollow box shape, and electric devices (including electronic devices), such as the J/B 47 and the electronic control unit (ECU) 51, may be housed inside the restraint plate 49. The J/B 47 includes, for example, electrical components such as a relay and a fuse, and connectors connected to the electrical components. The ECU51 executes processing related to management of the power storage apparatus 1 (for example, monitoring of the voltage and temperature of each power storage cell 11, and control of the temperature). In addition, the case lid 22 may be formed so as to also function as the restraint plate 49.

### 1-4. Assembly of Power Storage Apparatus

When the power storage module 10 is assembled into the power storage case 20, one side surface of the power storage case 20 is opened as the opening 23 as shown in FIG. 3. The power storage module 10 is inserted into the power storage case 20 (case body 21) using the opening 23. To be more specific, the power storage module 10 is inserted into the case body 21 in a state in which the positions of the protruding portions 13U and 13L of the power storage module 10 are aligned with the positions of the guide grooves 27U and 27L, respectively. Inside the case body 21, the power storage module 10 slides in the insertion direction D1 while the protruding portions 13U and 13L are guided by the guide grooves 27U and 27L, respectively, and moves to a predetermined assembly position.

The components of the power storage apparatus 1, such as the power storage modules 10, the inter-module bus bars 40, the elastic members 48, and the restraint plate 49, may be inserted into the power storage case 20 and assembled in order starting from the component located at the front in the insertion direction D1. Alternatively, the components may be assembled into an assembly as follows before being attached to the power storage case 20, for example. That is, first, the elastic member 48 may be interposed between the two power storage modules 10, and then the two power storage modules 10 may be connected by the inter-module bus bars 40 (for example, 40-1 and 40-2). Next, the remaining elastic members 48 may be attached to each of the power storage modules 10. The assembly thus obtained, including the power storage modules 10, the bus bars 40, and the elastic members 48, may be inserted into the power storage case 20 so as to slide until the assembly abuts against the wall (i.e., the cover 26) inside the power storage case 20. The restraint plate 49 may then be fastened by the bolts 50 to restrain the assembly. After the restraint plate 49 is attached, the case lid 22 is fixed to the case body 21 by the bolts 24.

In an example in which a plurality of power storage modules 10 are assembled, such as the example shown in FIG. 1, the ease of assembly of the power storage apparatus 1 can be favorably improved by connecting the plurality of power storage modules 10 in advance using the inter-module bus bars 40 as described above. In addition, by connecting the plurality of power storage modules 10 using the inter-module bus bars 40, the workability is also improved when the plurality of power storage modules 10 are removed from the power storage case 20.

### 1-5. Shape of Outer Surface of Power Storage Case

FIG. 6 is a perspective view of the power storage case 20 in which components, such as the power storage module 10, are assembled. As described above, the case body 21 has a rectangular parallelepiped shape (or a cubic shape). The inner surface 21UI (first inner surface) of the upper wall 21U and the inner surface 21LI (second inner surface) of the lower wall 21L of the case body 21 are formed with the guide grooves 27U and 27L, respectively. In contrast, as shown in FIG. 6, each of outer surfaces 21UO, 21LO, 21S1, and 21S2 of the case body 21 is a flat surface. Broadly speaking, the power storage case 20 including the case lid 22 and the cover 26 together with the case body 21 also has a rectangular parallelepiped shape (or a cubic shape), and each of the outer surfaces of the power storage case 20 is also flat.

### 1-6. Other Structural Examples Regarding Guide Grooves and Protruding Portions

Unlike the example shown in FIG. 2A, two or more guide grooves 27U (first guide grooves) may be formed on the inner surface 21UI (first inner surface) of the power storage case 20 (case body 21). In correspondence with this, two or more protruding portions 13U (first protruding portions) may be formed on the outer surface 12UO (first outer surface) of the module case 12. The same applies to the pair of the guide groove 27L (second guide groove) and the protruding portion 13L (second protruding portion). Furthermore, the same applies to the example shown in FIG. 2B.

Moreover, unlike the example shown in FIGS. 2A and 2B, the “first outer surface” on which the “first protruding portion” is formed may be the outer surface of one of the side walls 12S3 and 12S4 of the module case 12, and the “first inner surface” on which the “first guide groove” is formed may be the inner surface of a side wall of the power storage case 20 that faces the one of the side walls 12S3 and 12S4. Also, the “second outer surface” on which the “second protruding portion” is formed may be the outer surface of the other of the side walls 12S3 and 12S4, and the “second inner surface” on which the “second guide groove” is formed may be the inner surface of a side wall of the power storage case 20 that faces the other of the side walls 12S3 and 12S4.

Furthermore, unlike the example shown in FIGS. 2A and 2B, the “first guide groove” may be formed on the outer surface 12UO (first outer surface) of the module case 12, and the “first protruding portion” may be formed on the inner surface 21UI (first inner surface) of the power storage case 20. Similarly, the “second guide groove” may be formed on the outer surface 12LO (second outer surface) of the module case 12, and the “second protruding portion” may be formed on the inner surface 21LI (second inner surface) of the power storage case 20.

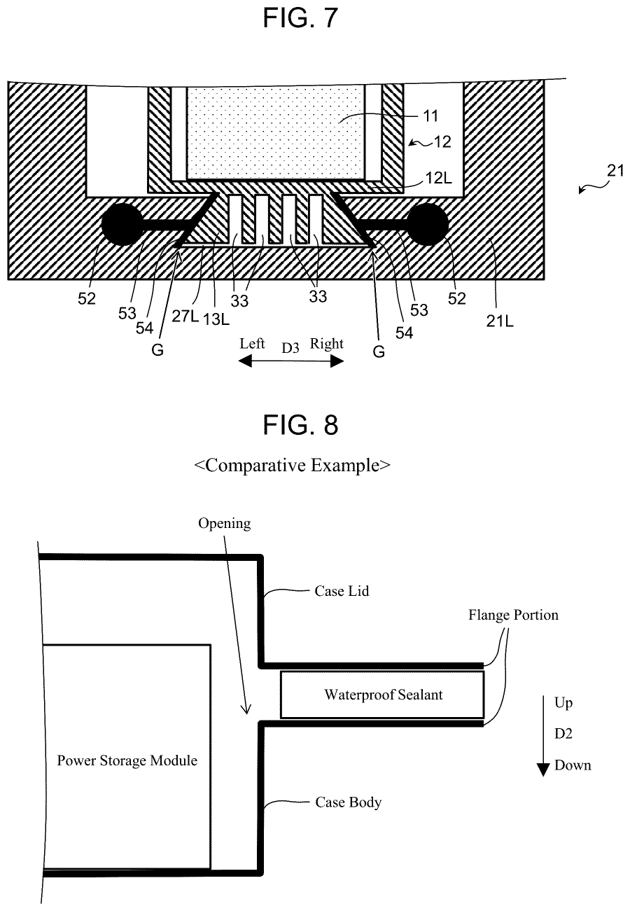

Next, FIG. 7 is a cross-sectional view showing another structural example of the case body 21 in which the guide groove 27L that engages with the protruding portion 13L having the cooling passage 33 is formed. In the example shown in FIG. 7, the lower wall 21L of the case body 21 additionally has the following structure. That is, a pair of flow passages 52 for injecting thermally conductive resin from the outside are formed in the lower wall 21L according to this example. The pair of flow passages 52 extend along the insertion direction D1, similar to the guide groove 27L. The thermally conductive resin has high thermal conductivity and is used to fill a pair of gaps G between the guide groove 27L and the protruding portion 13L that faces each other in the left-right direction D3. The thermally conductive resin is injected into the pair of gaps G from each of the pair of flow passages 52 via a flow passage 53 in a state in which the power storage module 10 is assembled to the case body 21 as shown in FIG. 7. The thermally conductive resin is then cured to form a pair of thermally conductive resin layers 54. The pair of thermally conductive resin layers 54 improves thermal conduction between the module case 12 and the power storage case 20 (i.e., heat dissipation to the power storage case 20), and thus improves the cooling performance of the power storage cells 11 using the cooling passages 33. Furthermore, according to the pair of thermally conductive resin layers 54, moisture contained in the cooling air can also be prevented from penetrating from the cooling passage 33 through the gaps (including the pair of gaps G) between the module case 12 and the power storage case 20 into the inside of the power storage case 20. In addition, the configuration shown in FIG. 7 may be similarly applied to the second shape example shown in FIG. 2B.

### 2. Effect

According to the power storage apparatus 1 of the present embodiment, when the power storage module 10 is assembled into the power storage case 20, the power storage module 10 slides along the insertion direction D1 while the protruding portions 13U and 13L are respectively guided by the guide grooves 27U and 27L as described above and moves to a predetermined assembly position. In this manner, a structure that facilitates assembly of the power storage module 10 into the power storage case 20 is obtained. That is, the ease of assembly of the power storage apparatus 1 is improved.

On the other hand, when the power storage module 10 is pressed against and fixed to the power storage case 20 as described above, it is also desirable to make the power storage module 10 less likely to come off in directions other than the pressing direction (that is, the insertion direction D1). In this regard, inside the power storage case 20, the guide groove 27U and the protruding portion 13U engage with each other on the side of the inner surface 21UI (first inner surface) of the upper wall 21U, and the guide groove 27L and the protruding portion 13L engage with each other on the side of the inner surface 21LI (second inner surface) of the lower wall 21L facing the inner surface 21UI. This provides a structure in which the power storage module 10 is less likely to come off from the power storage case 20 even if an external force acts on the power storage case 20 from a direction other than the pressing direction described above.

Moreover, the first protruding portion (for example, 13U or 14U) is engaged with the first guide groove (for example, 27U or 28U) such that the movement of the module case 12 with respect to the power storage case 20 is restrained in each of the vertical direction D2 and the left-right direction D3. The same applies to the relation between the second protruding portion and the second guide groove. This provides a structure in which the power storage module 10 is less likely to come off from the power storage case 20 in the vertical direction D2 or the left-right direction D3 when an external force acts on the power storage case 20.

Moreover, inside the first protruding portion (for example, 13U or 14U) formed on the outer surface 12UO of the module case 12, the smoke exhaust passage (for example, 29 or 30) is formed. This allows the smoke to be exhausted by using the first protruding portion and the first guide groove that are provided to improve the ease of assembly of the power storage module 10 and the resistance to detachment thereof.

Therefore, compared to an example in which a component for forming a smoke exhaust passage is added in addition to the first protrusion portion, it is possible to promote space saving for the power storage case 20. In addition, the smoke exhaust passage enables more efficient smoke exhaust in an example in which the power storage cells 11 are arranged in the module case 12 such that the smoke exhaust valve 15 faces upward in the vertical direction D2 (see FIGS. 2A and 2B).

Furthermore, inside the second protruding portion (for example, 13L or 14L) formed on the outer surface 12LO of the module case 12, the cooling passage (for example, 33 or 34) is formed. This makes it possible to cool the power storage cells 11 by using the second protruding portion and the second guide groove that are provided to improve the ease of assembly of the power storage module 10 and the resistance to detachment thereof. Therefore, compared to an example in which a component for forming a cooling passage is added in addition to the second protrusion portion, it is possible to promote space saving for the power storage apparatus 1. Moreover, according to the cooling passage, the module case 12 that houses the power storage cells 11 can be directly cooled, and the power storage cells 11 can thus be cooled more effectively than an example in which a cooling passage is provided to cool the power storage case 20. Furthermore, the cooling passage is formed so as not to communicate with the inside of the module case 12. This makes it possible to cool the power storage cells 11 while preventing water from entering the inside of the module case 12 through the cooling passages.

FIG. 8 is a schematic view showing a cross section of a power storage case according to a comparative example. In a general power storage case (pack case) having a case body (lower case) and a case lid (upper case) for housing a power storage module, a flange portion may be provided for covering, with the case lid, an opening of the case body that is parallel to the horizontal direction. For the purpose of arranging a waterproof sealant, the flange portion may be formed so as to protrude in the horizontal direction from each of the lower case and the upper case as shown in FIG. 8. This may impose restraints on mounting a power storage pack on various moving bodies. In contrast, as described above, at least each of the outer surfaces 21UO, 21LO, 21S1, and 21S2 of the case body 21 of the power storage case 20 is a flat surface. This contributes to improve the ease of mounting the power storage apparatus 1 on various moving bodies when the power storage apparatus 1 is configured as a power storage pack.

Additionally, in the power storage case 20, the opening 23 for inserting and removing the power storage module 10 is formed only on one side surface of the case body 21 as illustrated in FIG. 1. This makes it possible to reduce the contact area between the case body and the case lid, compared to an example in which the power storage case 20 is formed to have a case body and a case lid that are divided into upper and lower parts in the vertical direction D2 as in the comparative example shown in FIG. 8. This also leads to space saving for the power storage case 20.

Furthermore, in the power storage apparatus 1, the protruding portion 13U is engaged with the guide groove 27U on the side of the upper wall 21U of the case body 21, and the protruding portion 13L is engaged with the guide groove 27L on the side of the lower wall 21L. As a result, for the power storage case 20, the module case 12 functions as a beam extending along the insertion direction D1 on each side of the upper wall 21U and the lower wall 21L. Therefore, compared to an example in which a reinforcing member for the power storage case 20 is separately provided, the power storage case 20 can be reinforced while achieving space saving. In addition, according to the module case 12 that functions as a beam as described above, it is possible to improve protection of the power storage cells 11 against an external force acting on the power storage case 20 from above or below in the vertical direction D2.

What is claimed is:

1. A power storage apparatus, comprising:
a power storage module including a plurality of power storage cells and a module case that houses the plurality of power storage cells; and
a power storage case that houses the power storage module, wherein a first guide groove that extends along a first direction is formed on one of a first inner surface of the power storage case and a first outer surface of the module case facing the first inner surface,
a first protruding portion that engages with the first guide groove is formed on another of the first inner surface and the first outer surface,
a second guide groove that extends along the first direction is formed on one of a second inner surface of the power storage case facing the first inner surface and a second outer surface of the module case facing the second inner surface, and
a second protruding portion that engages with the second guide groove is formed on another of the second inner surface and the second outer surface.

2. The power storage apparatus according to claim 1, wherein
the first inner surface and the first outer surface are located above the plurality of power storage cells in a vertical direction,
the second inner surface and the second outer surface are located below the plurality of power storage cells in the vertical direction,
the first protruding portion is engaged with the first guide groove such that movement of the module case with respect to the power storage case is restrained in each of the vertical direction and a left-right direction that is perpendicular to each of the vertical direction and the first direction, and
the second protruding portion is engaged with the second guide groove such that the movement of the module case with respect to the power storage case is restrained in each of the vertical direction and the left-right direction.

3. The power storage apparatus according to claim 2, wherein
the first protruding portion is formed on the first outer surface, and
a smoke exhaust passage which communicates with an inside of the module case and through which smoke from the plurality of power storage cells flows is formed inside the first protruding portion.

4. The power storage apparatus according to claim 2, wherein
the second protruding portion is formed on the second outer surface, and
a cooling passage through which a refrigerant for cooling the plurality of power storage cells flows is formed inside the second protruding portion so as to extend along the first direction without communicating with an inside of the module case.

5. The power storage apparatus according to claim 1, wherein
the power storage case includes a case body including the first inner surface and the second inner surface, and
at least each of outer surfaces of the case body of the power storage case is a flat surface.
